SEQUENCE LISTING (12 sequences)

SEQ ID NO: 1 - DNA, 1092 bp, Chlorella Virus PBCV-1
  CDS (1)..(1092)
atgtctcaagtagacaccgtggtagactccgtggtagacgtcgaaaaccatcagcccacacatatcgacactttcccatacaataaacgggttattgaatctaaacccaaaaaaaatatgattgtccgcggtgttgttatttgcatggcgatccttattttcgggggagcaattgccacagcaattgtggtgagttctgataattcctcagaccaggccccagctccagcgccaggaccagcccttatttacaaaggcgcgtatattgacgaacctccgccgtttgaaccaaaggctgggtttgaagccatgtggtgggatgagtttgacggcgaagaaatcgaccgtacaaaatggtacatccagcccgatattgttgattattataccgggaatagacagattcaacattatattgattctccttctacaatagaagtatccaacgatacacttcacattattgccaataaccctggtgaagtgcaatataacgaaacctcgagtaactacgatcaaacatattacacttcagcgcgcataaacacaaaaacaactggaggacattggtatccggggatggaggtaaatggtacaacgtggaataccattcgagtagaggcgcggctaaaggcgccgagaggtccgggagttgtcggtgctttttggatgctacctattgacaatagttgcttcccagaaattgatatttttgagacgccatactgcgaaagagcatccatgggcacgtggtacgtaaacaaagatgtcccaagaggtatctcaaagcatggcaccacgatcacggaaagttatgataagttttgtgacgaatacgttacatatgccgttgaatggaacgcagattatattgcattttatgcgggtgacgctgaaaccccggtttttgtgactggaaaagaaatctgggctggaaaatgcgatgcaaacgatactgatgcaccttacaaccgacctttttatattattctgaatacatctatcgggtccgcatggggcggtatcccattgaatgatattttccctgcagttctagacgtagactacgtgcgggtttcaggcattcgcgat

SEQ ID NO: 2 - protein, 364 aa, Chlorella Virus PBCV-1
MSQVDTVVDSVVDVENHQPTHIDTFPYNKRVIESKPKKNMIVRGVVICMAILIFGGAIATAIVVSSDNSSDQAPAPAPGPALIYKGAYIDEPPPFEPKAGFEAMWWDEFDGEEIDRTKWYIQPDIVDYYTGNRQIQHYIDSPSTIEVSNDTLHIIANNPGEVQYNETSSNYDQTYYTSARINTKTTGGHWYPGMEVNGTTWNTIRVEARLKAPRGPGVVGAFWMLPIDNSCFPEIDIFETPYCERASMGTWYVNKDVPRGISKHGTTITESYDKFCDEYVTYAVEWNADYIAFYAGDAETPVFVTGKEIWAGKCDANDTDAPYNRPFYIILNTSIGSAWGGIPLNDIFPAVLDVDYVRVSGIRD

SEQ ID NO: 3 - DNA, 3096 bp, Chlorella Virus PBCV-1
  CDS (1)..(3096)
atgggatcgtattttgtcccaccggcgaattattttttcaaagatattttcgcgtcaaatgttggaaacatagcaaacgtaatttttgataacggtaatgttatagctgccggaggtcttggttacttaataggtaacggcgcattcatcacgggagtcacatcaactgcaatagcgaacattccagcagtagtgaccgcagatatccgcggaaatctcatcggtaactacgccaatgtcaacaatataattgcatcatctggaaacatctctaacgtcagattcgtatcgggtggaaacgtgacggcatcttattatttcggagatgggtctcagttgactggtatcaccgcgactgctaatatcccatccatagtgactgcagacatccgaggtaacatcatcggtaattacgcaaacgtcagcaacgtatctgcaaccttcggaaacatcgcgaacgtgctgttcaacaacggtaatgtgacggcagcgggtggtaacgggttctttataggaaacggatcgctgttgaccggaatcaccgcgactgctaatatcccatccatagtgactgcagacatccgaggtaacatcatcggtaattacgccaacgtcagcaacgtatctgcaaccttcgggaacatcgcaaatgtgttgttcaacaacggaaacgtaacggcagcgggtggtaacgggtacttcttcgggaatggggcgttgttgaccggaatcaccgcgactgctaatatcccatccatagtgaccgcagacatccgaggtaacatcatcggtaattacgccaacgtcagcaacgtatctgcaaccttcgggaacatcgcaaatgtgttgttcaacaacggaaacgtaacggcagcgggtggtaacgggtacttcttcgggaatggggcgttgttgaccggaatcaccgcgactgctaatatcccatccatagtgactgcagacatccgcggaaacatcatcggtaactacgccaacgtcagcaacgtatctgcaaccttcggaaacatcgcgaacgtgttgttcaataatggaaacgtaacggcagcgggtggtaatgggttcttcatcggaaatgggtcgttgctgtctggtatcaccgcgactgctaatataccatccatagtgactgcagatatccgaggtaacatcattggcaactatgcaaacgtcagcaacgtaacggcaacgtttggaaacatcgcaaatgtgttattcaacaatggaaacgtaacggcagcgggtggtaatggttatttcttcgggaacgggtcccagttgaccggtgtcactgccactttaccttccatagtaaccgcagacatccgcggaaacatcattggcaactacgcaaacgtcagcaacgtaatcgcaacgttcggaaacatcgcaaatgtgttattcaacaatggaaacgtaacggcagcggatggcaatggttacttcttcgggaatgggtcccaattgaccggtgtcactgccactttaccttccatagtaaccgcagacatccgcggaaacatcattggcaactacgcaaacgtcagcaacgtaatcgcaacgttcggaaacatcgcaaatgtgttattcaacaatggaaacgtaacggcagcgggtggtaacggttacttcttcgggaatggggcgttgttgaccggaatcaccgcgactgctaatatcccatccatagtgactgcagacatccgcggaaacatcattggcaactacgcaaacgtcagcaacgtaatcgcaacgttcggaaacatcgcaaatgtgttattcaacaatggaaacgtaacggcagcggatggcaatggttacttcttcgggaatgggtcccaattgaccggtgtcactgccactttaccttccatagtaaccgcagacatccgcggaaacatcattggcaactacgcaaacgtcagcaacgtaatcgcaacgttcggaaacatcgcaaatgtgttattcaacaatggaaacgtaacggcagcgggtggtaacggttacttcttcgggaatggggcgttgttgaccggaatcaccgcgactgctaatatcccatccatagtgactgcagacatccgcggaaacatcatcggtaattacgcaaacgtcagcaacgtaacggcaacgttcggaaacatcgcgaacgtgttgttcaacaacggaaacgtgacggcagcgggtggtaatggttatttcttcgggaacgggtcccagttgaccggtgtcactgccactttaccttctatagtaaccgcagacatccgcggaaacatcatcggtaactacgcaaacgttagcaacgtaatcgcaacctttgggaacatcgcgaacgtgttgttcaataatggaaacgtaacggcagcgggtggtaacgggtacttcttcgggaatggggcgttgttgaccggaatcaccgcgactgctaatataccttctatagtgactgcagacattcgaggtaacatcatcggtaactatgccaacgtcagcaacgtaacggcaaccttcggaaacatcggaaacgtgctgttcaacaacggtaacgtaactgcagcaggcggtaacgggtacttcttcggaaacggaactttcctcaacttttccactataactgccgatatccgcgggaacatcataggcaactatgcaaacgtcgggaacgttattgcaggtaacgtatcaacaaccctcggaaacatcggaaacgtgctgttcaacaacggtaacgtaacggcagcaggcggtaacgggtacttctttggaaatggtacctcactcactttttctacgataagagctgatattcgcggaaatatcattggtaattatgccaacgttgcaaacgtgatcgcgggtaatgtcaactcaacctttggaaacatcgctggtgttacatttgacgctggaaacgtatcatcgcccgtggacattttggtgtctggtaatgtatctgtaggttctgatggattattcagaggtccaactaaccaatcaaacaatgcactaattttaagaggtattggaggtacaaacactgttaatctgttcagtataggtgctccttcgggtcag

SEQ ID NO: 4 - protein, 1032 aa, Chlorella Virus PBCV-1
MGSYFVPPANYFFKDIFASNVGNIANVIFDNGNVIAAGGLGYLIGNGAFITGVTSTAIANIPAVVTADIRGNLIGNYANVNNIIASSGNISNVRFVSGGNVTASYYFGDGSQLTGITATANIPSIVTADIRGNIIGNYANVSNVSATFGNIANVLFNNGNVTAAGGNGFFIGNGSLLTGITATANIPSIVTADIRGNIIGNYANVSNVSATFGNIANVLFNNGNVTAAGGNGYFFGNGALLTGITATANIPSIVTADIRGNIIGNYANVSNVSATFGNIANVLFNNGNVTAAGGNGYFFGNGALLTGITATANIPSIVTADIRGNIIGNYANVSNVSATFGNIANVLFNNGNVTAAGGNGFFIGNGSLLSGITATANIPSIVTADIRGNIIGNYANVSNVTATFGNIANVLFNNGNVTAAGGNGYFFGNGSQLTGVTATLPSIVTADIRGNIIGNYANVSNVIATFGNIANVLFNNGNVTAADGNGYFFGNGSQLTGVTATLPSIVTADIRGNIIGNYANVSNVIATFGNIANVLFNNGNVTAAGGNGYFFGNGALLTGITATANIPSIVTADIRGNIIGNYANVSNVIATFGNIANVLFNNGNVTAADGNGYFFGNGSQLTGVTATLPSIVTADIRGNIIGNYANVSNVIATFGNIANVLFNNGNVTAAGGNGYFFGNGALLTGITATANIPSIVTADIRGNIIGNYANVSNVTATFGNIANVLFNNGNVTAAGGNGYFFGNGSQLTGVTATLPSIVTADIRGNIIGNYANVSNVIATFGNIANVLFNNGNVTAAGGNGYFFGNGALLTGITATANIPSIVTADIRGNIIGNYANVSNVTATFGNIGNVLFNNGNVTAAGGNGYFFGNGTFLNFSTITADIRGNIIGNYANVGNVIAGNVSTTLGNIGNVLFNNGNVTAAGGNGYFFGNGTSLTFSTIRADIRGNIIGNYANVANVIAGNVNSTFGNIAGVTFDAGNVSSPVDILVSGNVSVGSDGLFRGPTNQSNNALILRGIGGTNTVNLFSIGAPSGQ

SEQ ID NO: 5 - DNA, 2490 bp, Chlorella Virus PBCV-1
  CDS (1)..(2490)
atggcgaccgtaccaagcacaaaactcgaattaaccgtttctaaaacatccgactggaataccggatatgacggacaattcaaacttgaaaacaagaatgattatgatattcttcaatgggggatgacatttgattttcctgaatctgaaaactttacatggttcagcgaaggcgaccttgttcgtaagggtaacaaggtgactatgataccaaaagattggaacatgtcaattcccgcgggaacgacgaaaatcataccttttggaggtgtgaaagctctccctggaaatcttaaatacaaccaaatcctaccactcgtaggtaaggatccttctttggcaaaaagaggtaaatggtcttctaaagccgtagccccgtacgtagacgcttgtgctttcccaactccagatctccccgcgatcagtaaagcaagcggactgaaattctttactcttgcgtttatcactgctgacagcaataacaaagcgagctgggcgggaactatccctctatcgagtcagcatcttctatcccaggtgcgccaaatcagaagttctggaggtgatatttctatttcgttcggcggtgcaaacggtatagaacttgcggatgctattaaggacgttgacgctcttgtagccgagtatagtagagtaatcgacttgtattctctgacacgtattgactttgatatcgaaggtggtgcggtcgctgataccgaaggagttgacagacgtaacaaagctatcaatatcttgaacaagaagtaccctaatttgcaaataacatactgtctccccgtgttaccaacaggacttgctctcgcgggtgaactcctggtgcgcaatgccagagtgaacaatgctataatacattcattcaacggtatgtcaatggattttggagattccgcggctcctgacccggaaggtcgtatgggagattatgtaataatgtcttgtcaaaaccttcgaacccaagttttgtccgctgggtatgattctccaaacataggaaccattcctatgatcggagttaacgacgtagagagtgaagtgttcagaatttctgacgcaaagaaggtgtatgatttcttccagagcatcccctggatgacctatgtcggtttttggtccacaaatcgcgacaatgcaggccagggtcaaggtgccaacccattcaattcgggtataaaacaaaacccgtatgactttagtaaaactttcctcggaaagaaagtactcgaattagaccccagtcctagaccaaacccccctcatatcccaccccctggtggagatcctaacccacttccacccgtaggccccgttgatcccagtcctaaacctcctacgccgaaacctcccacaccaaatcctcctaccaatcctgaaaaaccccagaaaccagttcagaaaccgaatgtgaacgcagattggtgcaacgtgtctctcgaattcgtacgcaggtgtcgtgacggcgaagcccctgatgcagtaattaaggatcttcaaacaagatattctggcctgggtccggaaaatcagaaggccctcaagaaacttcttgacccctcaaagcccgttgaccctaaacccgttgaccctaaacccgttgaccctaaacccgttgaccctaaaccacctgttaaaagcaatcgatttttcacaccatacacagagtcttggcaatattggagtgggtggaacaatgccaagactctagaacaaattccaacaaagaacgtgactcttgcattcgtattatacgccgatggtgttcctaagttcgacgggactatggacgcgaatatttatgttgaccaggcgaaaatagtccagactaagggcggaatcgtccgtatttctttcggtggtgccactggaactgaactagcactcggtatcaaagacgtaaacaaacttgctgctgcatatgaaagcgtcataaagatgtacaataccagaaatattgatatggacatcgaaggaggccccgcttctgacatggatagtatcactcgtagaaacaaggcgcttgtcattttgcaaaagaagtatccagatttgaaagtcgactatactctcgcggtgatgcaaacaggtctttccactcagggattggatatcctgaaggatgcgaaaaaacaaggtctaaaagtccacgcagtgaatatcatggctatggactatggcactaatgaaaaacaaatgggaaaagcagcgatcagtgccgctactgcaacgaagaagcagtgtgatgacttgggcctcgtttatgaaggtgtgggcatcaccccgatgatcggtctaaacgacacatctccggaaacatttactattgataacgccaaggaagtcgtcgatttcgcaaagaaaacgtcttgggtaaatttcttgggattttgggcgaccgggcgtgacaatgccaaagataccaaagttaagcaagtgatgtgggaattcacaaatatattcaacacatttgcg

SEQ ID NO: 6 - protein, 830 aa, Chlorella Virus PBCV-1
MATVPSTKLELTVSKTSDWNTGYDGQFKLENKNDYDILQWGMTFDFPESENFTWFSEGDLVRKGNKVTMIPKDWNMSIPAGTTKIIPFGGVKALPGNLKYNQILPLVGKDPSLAKRGKWSSKAVAPYVDACAFPTPDLPAISKASGLKFFTLAFITADSNNKASWAGTIPLSSQHLLSQVRQIRSSGGDISISFGGANGIELADAIKDVDALVAEYSRVIDLYSLTRIDFDIEGGAVADTEGVDRRNKAINILNKKYPNLQITYCLPVLPTGLALAGELLVRNARVNNAIIHSFNGMSMDFGDSAAPDPEGRMGDYVIMSCQNLRTQVLSAGYDSPNIGTIPMIGVNDVESEVFRISDAKKVYDFFQSIPWMTYVGFWSTNRDNAGQGQGANPFNSGIKQNPYDFSKTFLGKKVLELDPSPRPNPPHIPPPGGDPNPLPPVGPVDPSPKPPTPKPPTPNPPTNPEKPQKPVQKPNVNADWCNVSLEFVRRCRDGEAPDAVIKDLQTRYSGLGPENQKALKKLLDPSKPVDPKPVDPKPVDPKPVDPKPPVKSNRFFTPYTESWQYWSGWNNAKTLEQIPTKNVTLAFVLYADGVPKFDGTMDANIYVDQAKIVQTKGGIVRISFGGATGTELALGIKDVNKLAAAYESVIKMYNTRNIDMDIEGGPASDMDSITRRNKALVILQKKYPDLKVDYTLAVMQTGLSTQGLDILKDAKKQGLKVHAVNIMAMDYGTNEKQMGKAAISAATATKKQCDDLGLVYEGVGITPMIGLNDTSPETFTIDNAKEVVDFAKKTSWVNFLGFWATGRDNAKDTKVKQVMWEFTNIFNTFA

SEQ ID NO: 7 - DNA, 963 bp, Chlorella Virus PBCV-1
  CDS (1)..(963)
atgaatggaaacgacaactgggataacgtagtaaaagattacaataatcttagaaaaaacggccatgatgaacaagaaacaatttcaataataagacgtaagtataccgacataggtcctgttaatcaaaaaaggttagaagaccaatacgaaaagataaaaccttcccaaaaacccgctccaaaacccgctcccaaaaccgcgccaaaatcccctccggcaacaaaaaatacaaatgttataagcacgttagatttgaatttgttaacaaaggggggtggttcttggaatgtagatggtgtgaacatgaagaaaagtgccgtgacaacatttgatggcaagcgtgtcgtcaaggctgtatatgataaaaactcagggacgagtgcaaaccccggggttggcgggttcagtttttccgcagttccggatggtcttaacaaaaacgccataacattcgcttgggaagtattttatccaaaaggattcgattttgcacgagggggcaaacacgggggaacgtttataggtcatggagctgcttctggatatcagcattctaaaacgggtgcatcgaataggatcatgtggcaacaagatggaggtgtcatagactacatttaccctccctctgatctaaaacaaaagatccgtggtctcgaccccgaagggcatggaatcggatttttcgaggatgactttaaaaaagcgctgaaatatgacgtatggaatcgtatagaaattggaacgaagatgaatactttcaagaacggggttcctcagttagatggcgaatcctatgttatcgtcaacggaaagaaggaggtcttaaaaggaataaattggtctagaagtcctgatttggtgataaacaggttcgattggaacacattttttggaggtccactcccaagtccaaagaatcaggtagcatacttcacgaatttccaaatgaagaaatacgaa

SEQ ID NO: 8 - protein, 321 aa, Chlorella Virus PBCV-1
MNGNDNWDNVVKDYNNLRKNGHDEQETISIIRRKYTDIGPVNQKRLEDQYEKIKPSQKPAPKPAPKTAPKSPPATKNTNVISTLDLNLLTKGGGSWNVDGVNMKKSAVTTFDGKRVVKAVYDKNSGTSANPGVGGFSFSAVPDGLNKNAITFAWEVFYPKGFDFARGGKHGGTFIGHGAASGYQHSKTGASNRIMWQQDGGVIDYIYPPSDLKQKIRGLDPEGHGIGFFEDDFKKALKYDVWNRIEIGTKMNTFKNGVPQLDGESYVIVNGKKEVLKGINWSRSPDLVINRFDWNTFFGGPLPSPKNQVAYFTNFQMKKYE

SEQ ID NO: 9 - DNA, 1515 bp, Chlorella Virus PBCV-1
  CDS (1)..(1515)
atggcccttgcgaaacctgctccgtattatacgagccccactggaaaacaggcaatatattaccatacttcatggagctgctacgacagaaagttctaccccgtcaaactaccaattgacaaacttacagacatcgcatacgcattcttcaacgttgatgagaccggtagggtattctccggagacgagtggagcgactaccaaatgccgttcaatggtcctggcgaaggcgttgaacctcaaaataaatgggattcaccacccgaacaattaggacaactaggtcagttcttgaaactgcttaaaaaggaacacaagttcaacatgcacgcgtctataggcgggtggagttggagtggtaatttttccaatgcggttaaaacagaggaaaatcgcgagaggttcgttaccagtctggcgggaatcatgaacagatacccaggtctatttaattctatttcgcttgactgggaatatgtgtcggacgatggtgtcaactatggtctaggcggaaacgccgttagcaaagaagaccccgataattttatgaaactcctaaagaaaatccgtcaaaagctcccaggttttaagatatcaatgtgcacaattgccgctccagaaaaacttaaattccccgtgaaaaaagtaagtgaacttctggacgaggttcacgtgatgacatacgatttccttgacgggtcgtgggcgcaaggaggtggtccagccactggacatcacacgaactttagtaaatcaccactcgttccctactcggtaaccgacgccgccgaaacgatgctcaaactcggtgttgaccctaaaaaaatattcgtcggtgttgcgttttattctagagggttcagtggcaccgatggtctaggaaaaccatatacaggcggttctacagacaaaacatgggacaatggttcggtagattataaatttttacccctacctggggcacaagaactatgggaccccgttgcaaacgctgcctattcatacgatccgaaaaaaagggtgttgaattcatacgacgaacctcgctctgtaaaactaaaatgcgactttgttcaccaaaaaggtctcggtggtatcttggtatgggaggattccgcagatcacccgtacgatcacccacgttcgctcatgaaaattattcacgataatctgacccacggggaaaatgccaaacccgaaccgacccccaaacccgaaccgacccccaaacccgaaccgaccccgaaacctgaacctactccaaaacctaaaccgacccccaaacccgaaccgacccccaaacctaaaccgacccccaaacctaaaccgacccccaaacctaaaccgaccccaaaacctaaaccgaccccgaccccgaagcctgacccgattcctaaagaaggtatttggggtgttgacggagaatcattcttttataatggtggtattaaaatgaattgtccaccagggctcgtatggaactcgacgagtaaatcttgtgattggcctaagaaa

SEQ ID NO: 10 - protein, 505 aa, Chlorella Virus PBCV-1
MALAKPAPYYTSPTGKQAIYYHTSWSCYDRKFYPVKLPIDKLTDIAYAFFNVDETGRVFSGDEWSDYQMPFNGPGEGVEPQNKWDSPPEQLGQLGQFLKLLKKEHKFNMHASIGGWSWSGNFSNAVKTEENRERFVTSLAGIMNRYPGLFNSISLDWEYVSDDGVNYGLGGNAVSKEDPDNFMKLLKKIRQKLPGFKISMCTIAAPEKLKFPVKKVSELLDEVHVMTYDFLDGSWAQGGGPATGHHTNFSKSPLVPYSVTDAAETMLKLGVDPKKIFVGVAFYSRGFSGTDGLGKPYTGGSTDKTWDNGSVDYKFLPLPGAQELWDPVANAAYSYDPKKRVLNSYDEPRSVKLKCDFVHQKGLGGILVWEDSADHPYDHPRSLMKIIHDNLTHGENAKPEPTPKPEPTPKPEPTPKPEPTPKPKPTPKPEPTPKPKPTPKPKPTPKPKPTPKPKPTPTPKPDPIPKEGIWGVDGESFFYNGGIKMNCPPGLVWNSTSKSCDWPKK

SEQ ID NO: 11 - DNA, 984 bp, Chlorella Virus PBCV-1
  CDS (1)..(984)
atgtcaaacaaaatagaaataacagacgataataaaatgacgattcaaaacgactttgtatcacggatgatgaagagtatcgatcaggaactcgttgccatgacgaacaaatattctgggttcggtcctggcagacagacgaattgcaaaaaagctcttgcaaaggccctcggagaaaccccagtcaaccccccagtcaaccccccagtaacccctcctgtagatacacatattccttcacaggtcgaagctcctttgaaaaaactaggcttcaatacaacaaatgcagacacgatcttatcactcatcgcgctcccggaaaactctacaacccaatggtggaaaaattacaattacgcaagttgtctaaaggacggtcgtggatggacagtaacaatttacggtgcatgctctgggactggtgatctgttgatggtattggagtctctgcaaaaaataaaccctaaccacccactcgtgaaattcatccccgcaatgaggaaaaccaagggagatgatatcagaggcctcgaaaatctcgggaaagtaatcaacgggctcggcgacgacaaagaatggcaaacggcggtgtgggacatatacgtcaaattatattggacttttgctgccgatttttcagacaagactggaagtgcgaaaaaccgccccgggcccgttatgacgtcaccattgacacgtggttttatggtagatgttgcgttgaaccacgggagtaatatggaatccttttccgacattctaaagagaatgaaaaatcgcgaagagaaagacgaggcgaaatggttcctcgatttctgcgagacaagacgtaaacttctaaaagctggtttccaagatcttgatacttctaaaacaggagatcgctgtacactttgggcaaacatcttcaaagaaggaaacgttgggctgaaacgcccgataaaatgctacaatggttactggggtaaaaacatagttatttca

SEQ ID NO: 12 - protein, 328 aa, Chlorella Virus PBCV-1
MSNKIEITDDNKMTIQNDFVSRMMKSIDQELVAMTNKYSGFGPGRQTNCKKALAKALGETPVNPPVNPPVTPPVDTHIPSQVEAPLKKLGFNTTNADTILSLIALPENSTTQWWKNYNYASCLKDGRGWTVTIYGACSGTGDLLMVLESLQKINPNHPLVKFIPAMRKTKGDDIRGLENLGKVINGLGDDKEWQTAVWDIYVKLYWTFAADFSDKTGSAKNRPGPVMTSPLTRGFMVDVALNHGSNMESFSDILKRMKNREEKDEAKWFLDFCETRRKLLKAGFQDLDTSKTGDRCTLWANIFKEGNVGLKRPIKCYNGYWGKNIVIS

(19) United States
(12) Patent Application Publication
(10) Pub. No.: US 2013/0171721 A1
(43) Pub. Date: Jul. 4, 2013

(54) DISRUPTION OF CELL WALLS FOR ENHANCED LIPID RECOVERY

(71) Applicant: Alliance for Sustainable Energy, LLC, Golden, CO (US)

(72) Inventors: Eric P. KNOSHAUG, Golden, CO (US); Bryon S. DONOHOE, Golden, CO (US); Henri GERKEN, Queen City, AZ (US); Lieve LAURENS, Denver, CO (US); Stefanie Rose VAN WYCHEN, Boulder, CO (US)

(73) Assignee: ALLIANCE FOR SUSTAINABLE ENERGY, LLC, Golden, CO (US)

(21) Appl. No.: 13/731,578

(22) Filed: Dec. 31, 2012

Related U.S. Application Data
(60) Provisional application No. 61/581,985, filed on Dec. 30, 2011.

(51) Int. Cl. C11B 1/10

(52) U.S. Cl. CPC C11B 1/10
USPC 435/271

(57) ABSTRACT

Presented herein are methods of using cell wall degrading enzymes for recovery of internal lipid bodies from biomass sources such as algae. Also provided are algal cells that express at least one exogenous gene encoding a cell wall degrading enzyme and methods for recovering lipids from the cells.

### CROSS-REFERENCE TO RELATED APPLICATIONS

This application claims priority to U.S. Provisional Application No. 61/581,985, filed Dec. 30, 2011, the contents of which are incorporated by reference in their entirety.

### CONTRACTUAL ORIGIN

The United States Government has rights in this invention under Contract No. DE-AC36-08GO28308 between the United States Department of Energy and Alliance for Sustainable Energy, LLC, the Manager and Operator of the National Renewable Energy Laboratory.

### REFERENCE TO SEQUENCE LISTING

This application contains a Sequence Listing submitted as an electronic text file entitled “NREL_{—}10-56_Seq_ST25.txt,” having a size in bytes of 78 kb and created on Dec. 27, 2012. Pursuant to 37 CFR §1.52(e)(5), the information contained in the above electronic file is hereby incorporated by reference in its entirety.

### BACKGROUND

Oil from algae is currently being investigated as a source of advanced biofuels capable of providing a significant portion of worldwide jet and diesel fuel needs. However, several technological hurdles remain, including the efficient extraction of lipids from the algal cells. The current technology primarily relies on flammable, environmentally toxic, and expensive solvents. In addition, most extraction processes require that algal biomass be dewatered to dryness, a significant cost contribution. Developing technology to eliminate solvent extraction will create a simple, environmentally sound, and economical lipid recovery process.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods that are meant to be exemplary and illustrative, not limiting in scope. In various embodiments, one or more of the above-described problems have been reduced or eliminated, while other embodiments are directed to other improvements.

Exemplary embodiments provide methods for recovering lipids from a cell by contacting the cell with at least one cell wall degrading enzyme and isolating lipids from the cell.

In certain embodiments, the cell wall degrading enzyme is a proteinase, chitinase, chitosanase, sulfatase, lyticase, lysosyme, alginate lyase or pectate lyase; or is A94L, Al22R, A181/182R, A215L, A260R, or A292L from the Chlorella virus PBCV-1. In some embodiments, the cell is a microbial cell, a yeast cell, or an algal cell, such as from the genus Chlorella (e.g., a strain of the species C. vulgaris), Nannochloropsis, or Selenastrum.

In certain embodiments, the cell expresses at least one exogenous gene encoding a cell wall degrading enzyme, which may be under the control of an inducible promoter.

In some embodiments, the step of contacting the cell comprises inducing the expression of the at least one exogenous gene encoding a cell wall degrading enzyme.

In certain embodiments, the induced exogenous gene is a gene isolated from the Chlorella virus PBCV-1, such as A94L, Al22R, A181/182R, A215L, A260R, or A292L.

In some embodiments, the induced cell is further contacted with an externally added cell wall degrading enzyme.

In certain embodiments, the methods further comprise a step of dewatering the cell prior to the step of contacting the cell with at least one cell wall degrading enzyme. The cell may be dewatered to about 10-40% solids prior to the step of contacting the cell with at least one cell wall degrading enzyme.

In some embodiments, the step of isolating lipids from the cell comprises extracting the lipids by mixing the contacted cells with a hexane/isopropanol solvent and recovering the lipids from the solvent. In various embodiments, the extraction is carried out at a temperature of about 18° C. to 30° C. or for a time of about 1 to 4 hours. In certain embodiments, the solvent is 3:2 hexane:isopropanol by volume.

Also provided are methods for recovering lipids from an algal cell by culturing the algal cell, inducing expression of a cell wall degrading enzyme in the algal cell, and extracting lipids from the algal cell by mixing the algal cell with a hexane/isopropanol solvent, separating out the solids, and recovering the lipids from the solvent.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 shows a model for release of internal algal oil bodies by internally or externally applied enzymes.

FIG. 2 shows the nucleic acid sequence (SEQ ID NO:1) for the Chlorella virus PBCV-1 enzyme designated A94L.

FIG. 3 shows the nucleic acid sequence (SEQ ID NO:3) for the Chlorella virus PBCV-1 enzyme designated Al22R.

FIG. 4 shows the nucleic acid sequence (SEQ ID NO:5) for the Chlorella virus PBCV-1 enzyme designated A181/182RL.

FIG. 5 shows the nucleic acid sequence (SEQ ID NO:7) for the Chlorella virus PB CV-1 enzyme designated A215L.

FIG. 6 shows the nucleic acid sequence (SEQ ID NO:9) for the Chlorella virus PBCV-1 enzyme designated A260R.

FIG. 7 shows the nucleic acid sequence (SEQ ID NO:11) for the Chlorella virus PB CV-1 enzyme designated A292L.

FIG. 8 shows transmission electron microscopy (TEM) images showing degradation of C. vulgaris cell walls by lysozyme.

FIG. 9 shows scanning electron microscopy (SEM) images showing degradation of C. vulgaris cell walls by lysozyme.

### DETAILED DESCRIPTION

Presented herein are methods of using cell wall degrading enzymes for recovery of internal lipid bodies from biomass sources such as algae. Existing lipid recovery processes largely involve toxic and expensive solvents. In an effort to avoid using solvents, alternative methods have been pursued that rely on external energy inputs in the form of ultrasound, electromagnetic pulses, physical disruption, or on chemical acid or base treatments to either augment or replace extraction. These methods are costly due to the high energy required to rupture the algal cell walls.

The present methods involve the low energy and chemical inputs exemplified by secretion in current fermentation processes, and take advantage of a natural, inducible cellular response. These methods involve contacting cells with cell wall degrading enzymes prior to recovering lipids produced by the cells. The enzymes may be added to the cells from external sources or may be produced within the cells—either constitutively or in an inducible manner.

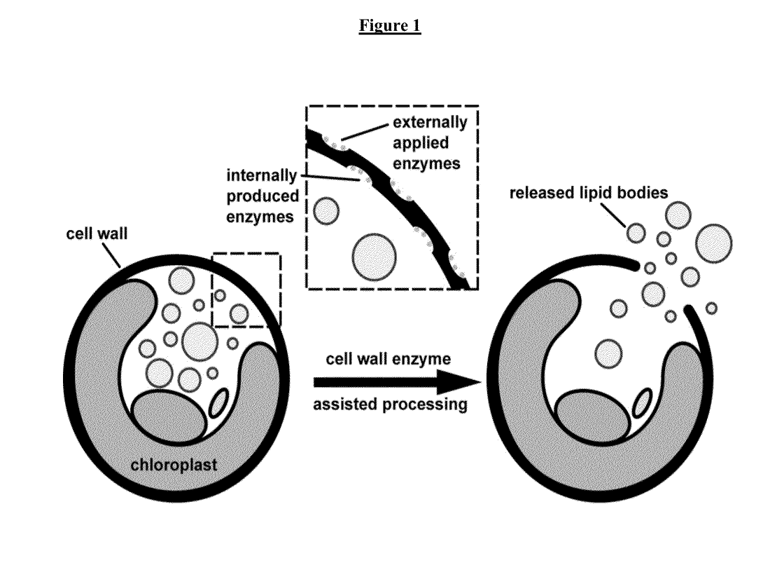

In one embodiment, one or more algal strains capable of high oil production may be subjected to a controlled, self-induced cell wall degradation that releases internal organelles and oil bodies under a controlled external stimulus. FIG. 1 illustrates a diagram for an enzyme-based process to facilitate the oil release. Such enzymatic treatment of algal biomass can also render the residual algal biomass pretreated in a way that downstream processes like nutrient recycling, anaerobic digestion, thermal depolymerization, or gassification may be more facile. Enzymatic degradation may thus also simplify the harvesting, dewatering, and oil extraction processes.

For example, algae may be partially dewatered, to about 20% solids, then induced for self-lysis by partial cell wall degradation. Oil bodies will escape from the cells and can be easily recovered by simply skimming the surface, using an established emulsion breaking process, or using a recycled portion of the algal oil stream for enhanced recovery. External enzymes may be added for cell wall degradation or the production of the enzymes may be established in algal cells under inducible promoter control that allows for the induction of enzymatic degradation and subsequent oil release.

Prior to enzyme treatment, cell samples may be concentrated or dewatered to increase the percentage of solids in the cell samples to be treated. Suitable methods for dewatering or concentrating cell samples include filtration, dissolved air floatation, or centrifugation. Cell cultures are typically dewatered to about 5% to about 40% solids, but the energy requirement and limits on ability to pump cell cultures should be considered.

Cell wall degrading enzymes refers to any with the ability to degrade components of cell walls such as those possessed by algae. Examples include the enzyme classes listed in Tables 2 and 3 below. For example, chitinase, lysozyme, or proteinase K can be used to degrade the cell walls of Chlorella sp. Suitable enzymes include proteinases, chitinases, chitosanases, sulfatases, lyticases, lysozymes, alginate lyases, or pectate lyases.

Additional enzymes suitable for use in the disclosed methods include cell disrupting enzymes expressed by lytic viruses such as the Chlorella virus PBCV-1. Exemplary PBCV-1 enzymes include those designated A94L, Al22R, A181/182R, A215L, A260R, and A292L.

Nucleic acid and amino acid sequences for these enzymes are included in Table 1 below:

TABLE 1
PBCV-1 Enzyme Sequences

| PBCV-1 Enzyme | Nucleic Acid Sequence | Amino Acid Sequence |
|---|---|---|
| A94L | SEQ ID NO: 1 | SEQ ID NO: 2 |
| A122R | SEQ ID NO: 3 | SEQ ID NO: 4 |
| A181/182R | SEQ ID NO: 5 | SEQ ID NO: 6 |
| A215L | SEQ ID NO: 7 | SEQ ID NO: 8 |
| A260R | SEQ ID NO: 9 | SEQ ID NO: 10 |
| A292L | SEQ ID NO: 11 | SEQ ID NO: 12 |

The PBCV-1 enzymes disclosed above exhibit the ability to degrade cell wall components such as those found in algal or yeast cells. These enzymes may be produced in recombinant systems and added exogenously to cell cultures. Because these enzymes are typically expressed in the green alga Chlorella, they may also be well suited for inducible expression in algal cells used for lipid production.

Enzymes in a quantity sufficient to degrade the cell walls are added to the cell culture either during active growth, stationary phase, or after de-watering to a paste to allow for cell wall degradation. Enzymes may be added directly to the culture or with additional salts or buffers to enhance enzyme activity. The amount of time needed for cell wall degradation will vary with the cell type, and can be readily determined by one of skill in the art. Enzymes are typically added in amounts ranging from about 1 mg/g of cell slurry to about 50 mg/g of cell slurry, but these numbers may be adjusted based on experimental observations. The total amount used may include one or more enzymes in various proportions. In some embodiments, enzymes are added to cell slurries of at least 5%, 10%, 15%, 20%, 25%, 30%, 35%, 40% or greater percentage solids.

Enzymes may be contacted with the cells for a few minutes to several hours. Exemplary times include from 30 minutes to 30 hours, including at least about 0.5, 1, 2, 5, 10, 15, 20, 25 or 30 hours. The temperature of the contacting step may be room temperature or a higher temperature depending on the enzyme used. While many enzymes exhibit higher activities at temperatures above room temperature, raising the temperature to increase activity can be balanced against the amount of energy needed to raise the temperature such that the most efficient temperature can be determined for a given enzyme/cell system. Contacting may be carried out at any temperature within the range of 10° C. to 50° C. or at a temperature ranging from about 18° C. to about 37° C. Exemplary temperatures include 10, 15, 20, 25, 30, 35, 40, 45 or 50° C. In some embodiments, the contacting is carried out at between 18° C. and 25° C., such as at 18, 19, 20, 21, 22, 23, 24 or 25° C.

The algal cell wall composition for a given candidate species will determine what enzymes are chosen to degrade the cell walls. Testing various digestive enzymes on the cells will provide information about specific linkages present in algal cell walls and how those linkages can be exploited to promote oil body release. Information gained in this way can then be used to formulate the optimal conditions to break down algal cell walls.

Two analyses may be employed to find effective enzymes: examining the impacts on colony growth, and the impacts on mature cells by tracking increasing permeabilization via the entry of a DNA staining dye. An enzyme impacting growth may be important during formation of the cell wall and may inhibit growth by preventing specific linkages from forming, thereby preventing a mature cell wall from being established. For mature cell walls these enzymes may target glycosidic bonds in the complex architecture of the mature cell wall.

A plate-based assay may be used to determine the effects of various enzymes from different classes on the growth of various relevant algae. By inoculating a dilute culture into appropriate nutrient containing soft top-agar and then spotting enzymes directly on this top-agar, while the dilute culture is growing, zones of inhibition will appear around active enzymes.

An exemplary method entails growing C. vulgaris as a confluent lawn on the surface of an agar plate and spotting enzymes on this lawn to analyze the inhibitory effects of enzymes on cell growth. Using this method, enzymes and cell wall disruptors were tested on the following strains; Ankistrodesmus falcatus ANKIS1, Chlorella sp. CHLOR1, C. emersonii, C. variabilis NC64A, C. vulgaris (UTEX 26, 30, 259, 265, 395, 396, 1803, 1809, 1811, and 2714), Ellipsoidon sp. ELLIP1, Franceia sp. FRANC1, Nannochloris sp. NANNO2, Nannochloropsis sp. NANNP2, Oocystis pusilla OOCYS1, Phaeodactylum tricornutum CCMP632, and Selenastrum capricornutum UTEX1648. Table 2 shows the results of various enzyme classes for C. vulgaris, Nannochloropsis, and Selenastrum.

TABLE 2
Growth inhibition in selected algae by various enzyme classes

| | Inhibition | | |
|---|---|---|---|
| Enzyme | C. vulgaris | Nannochloropsis | Selenastrum |
| Alginate Lyase | No | No | No |
| Sulfatase | ++ | +++ | +++ |
| β-glucuronidase | ++ | ++ | +++ |
| Cellulase | No | No | No |
| Chitinase | +++ | +++ | No |
| Chitosanase | + | ++ | No |
| Dreiselase | No | No | No |
| Hemicellulase | No | No | No |
| Hyaluronidase | No | ++ | No |
| Lysozyme | +++ | +++ | +/− |
| Lyticase | No | +++ | No |
| Macerozyme | No | No | No |
| Pectinase | ++ | ++ | ++ |
| Pectolyase | No | No | +++ |
| Trypsin | + | +++ | No |
| Xylanase | No | No | No |
| Zymolyase | No | ++ | ++ |

As shown above, several enzymes—sulfatase, β-glucuronidase, pectinase, and lysozyme—inhibit growth of these three species. Other enzymes inhibit one or two of the species while several enzymes do not inhibit the growth of any tested species. Cellulase, hemicellulase, and xylanase do not inhibit growth of any of the three species suggesting a lack of accessible cellulose or hemicelluloses such as found in higher plant cell walls. Alginate lyase, which cleaves β-1-4 mannuronic bonds, also showed no inhibition of growth.

Enzymes may be further evaluated both alone and in combination with lysozyme for cell wall degrading effects on mature, nitrogen sufficient cells in overnight digestions. The cells may be incubated with a DNA fluorescent staining dye, such as SYTOX green, which only stains compromised, permeable cells and then subjected to image-based analysis using the ImagestreamX, thus providing a quantifiable measure of increased permeability In the absence of enzymes, cells are typically not permeable to the dye and after exposure to various enzymes, a portion of the population may become permeable. Results for selected enzymes on C. vulgaris, Nannochloropsis, and S. capricornutum are presented in Table 3.

TABLE 3
Percentage of population that becomes permeable after enzymatic treatment

| | C. vulgaris | | Nannochloropsis | | Selenastrum | |
|---|---|---|---|---|---|---|
| | % | % permeable + | % | % permeable + | % | % permeable + |
| | permeable | lysozyme | permeable | lysozyme | permeable | lysozyme |
| no enzyme | 2.2 | — | 0.3 | — | 0.5 | — |
| sulfatase | 1.5 | 98.8 | 63.8 | 96.5 | 0.8 | 30.9 |
| β-glucuronidase | 2.6 | 54.1 | 0.3 | 6.2 | 1.3 | 2.7 |
| cellulase | 1.2 | 21.1 | 0.3 | 19.3 | 0.8 | 12.1 |
| lysozyme | 11.9 | — | 15 | — | 1.3 | — |
| lyticase | 1.09 | 48.4 | 0.2 | 37.8 | 1.6 | 61.3 |
| pectinase | 1.45 | 32.7 | 4.8 | 6.3 | 1.6 | 7.6 |
| trypsin | 0.9 | 29.9 | 0.6 | 68.7 | 1.6 | 9.2 |

The results of the cell permeabilization experiments suggest that a coating of chitodextrin (β-1-4 linked N-acetylglucosamine) or peptidoglycan (β-1-4 linked N-acetylmuramic acid and N-acetylglucosamine) type material, both polymers sensitive to lysozyme, surrounds or otherwise protects many of the other polymers from enzymatic attack. Lysozyme strips away or damages the outer layer, allowing other enzymes to act on the cell wall causing increased permeabilization. Treating C. vulgaris with lysozyme and sulfatase permeabilizes nearly 100% of the cells whereas with lysozyme alone, 12-15% of the population is permeabilized. Sulfatases hydrolyse O— and N— linked sulfate ester bonds suggesting that sulfated polymers are integral to cell wall architecture in C. vulgaris.

Some enzymes have a large effect on growing cells by inhibiting growth yet do not seem to have much effect on permeabilizing the cell walls of mature cells. As an example, cellulase and lyticase applied individually do not have much effect on growth. However, each in combination with lysozyme permeabilizes up to 20 and 40% of the C. vulgaris population respectively. These results suggest that algal cell wall sensitivities to enzymatic activities may change as the cell matures.

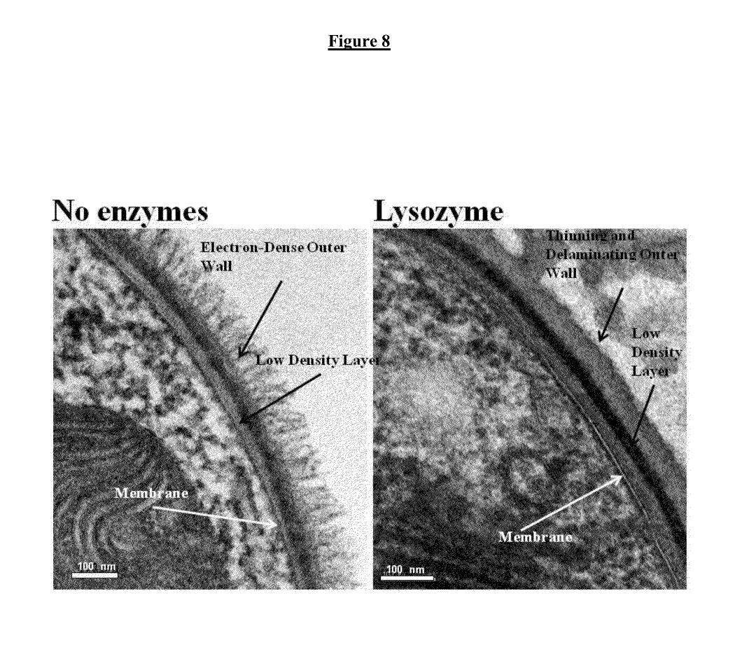

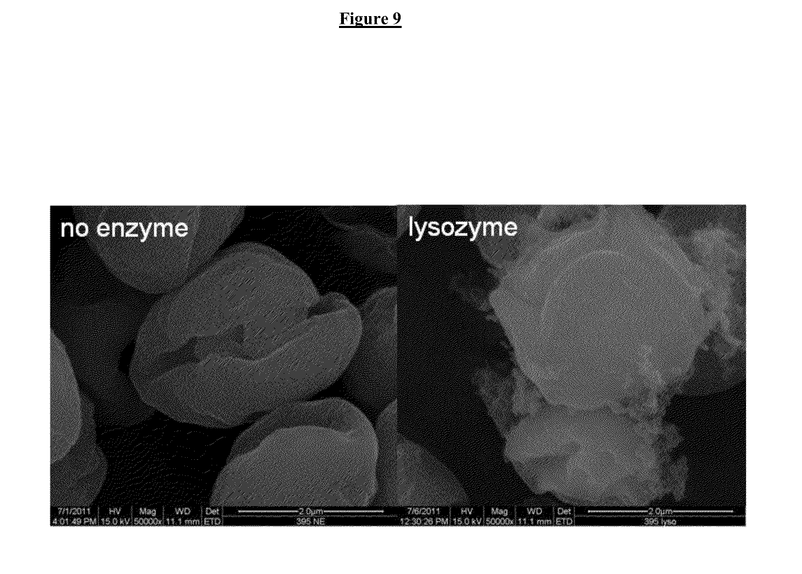

Transmission and scanning electron microscopy may be used to directly visualize the effects of enzymes on algal cell walls. C. vulgaris cells were digested with various enzymes or combinations of enzymes and processed to yield images that display the action of these enzymes on the algal cells. For imaging analyses, thin sections of embedded algae were stained and visualized using transmission electron microscopy (TEM), producing images of the cell walls of algal cells under nitrogen replete and deplete (high lipid producing) conditions. As shown in FIG. 8, TEM micrographs reveal the complete loss of the hair-like fiber layer of the outer wall surface, swelling of the outer layers, and a peeling or dissolution of material from the outer cell wall. It is typical for a complex, compact, layered cell wall to swell significantly as its internal cross-linked structure is weakened. FIG. 9 shows the same amorphous extracellular matrix from degradation of the cell wall using scanning electron microscopy (SEM). The cell wall does not need to be entirely digested to improve oil extraction.

Growth assays, permeabilization, and surface characterization studies may provide useful information on the types of linkages present and indicate how to functionally degrade the algal cell walls. Using the data from these experiments, a cocktail of enzymatic activities for efficient cell wall disruption can be created either from enzymes in-hand or through the mining of transcriptomic and proteomic datasets to provide sequence data on native enzymes possessing the desired enzymatic activity. Some native, intracellular cell wall degrading enzymes needed for cell division to partially degrade the algal cell wall have been described and may be suitable for use in the methods described herein. A combination of synergistic enzymatic activities may be needed to penetrate or weaken the cell wall sufficiently to enhance lipid extraction. Engineering an algal strain to reproduce a small number of additional enzymes will likely not pose much of a metabolic burden.

Production organisms may also be developed to allow the tightly controlled induction of cell-wall degrading enzymes. The genes encoding the enzymes of interest may be placed under the appropriate expression controls and stably transformed into the host organism. Native expression systems may be utilized to effectively express cell wall degrading enzymes in a green alga such as C. vulgaris. Particularly suitable are those that are tightly regulated and have a rapid, specific, and effective signal to induce high levels of expression. Inducible promoters responding to changes in pH, temperature, or the presence of an inducing chemical may be used to achieve internal, tightly controlled expression of cell wall degrading enzymes.

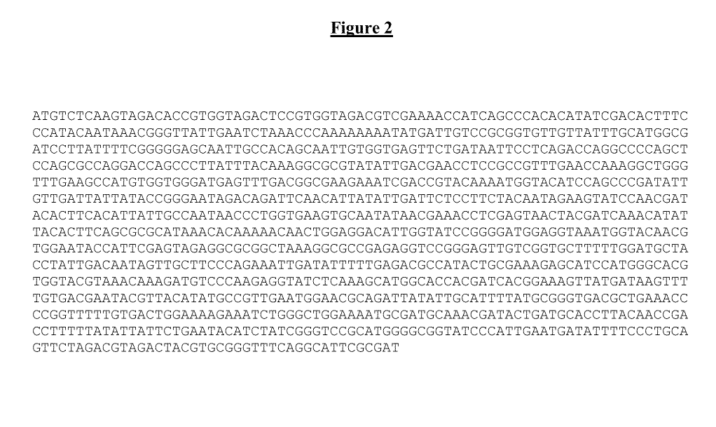

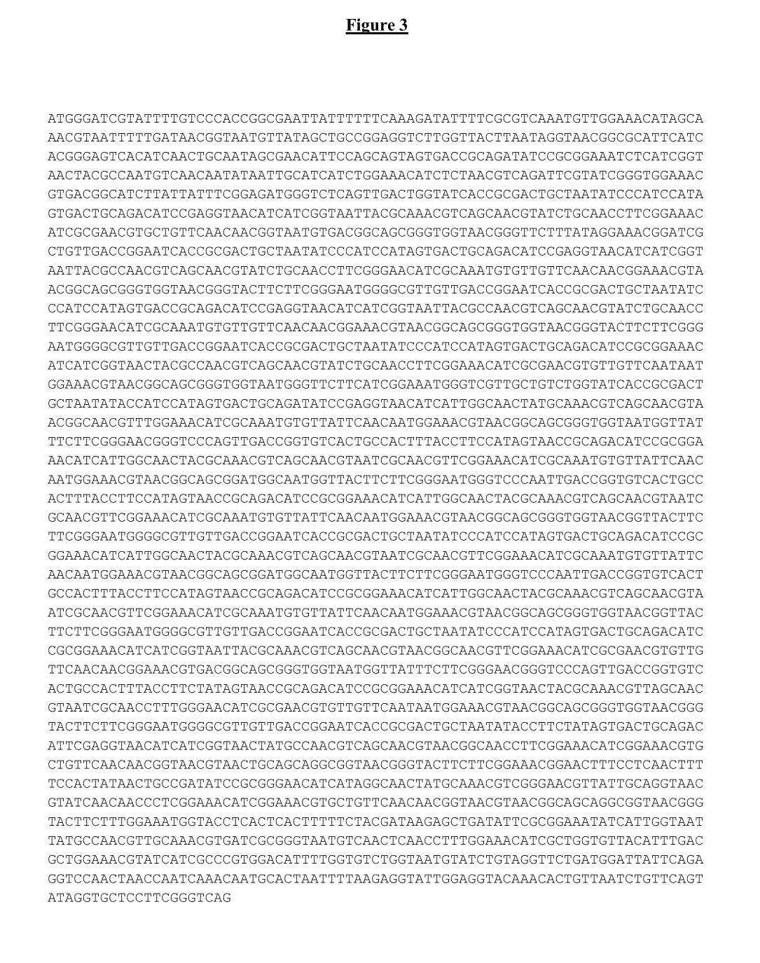

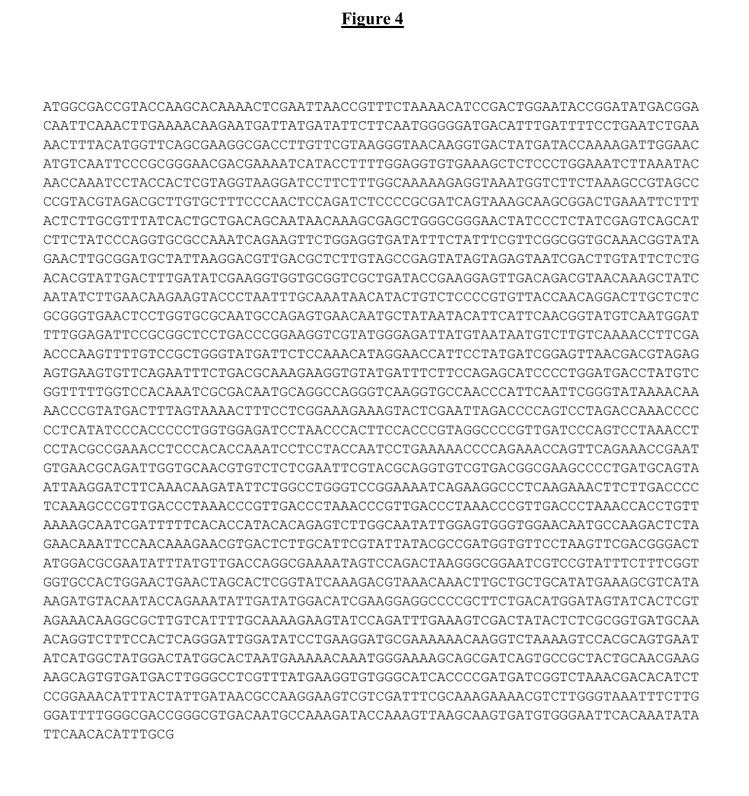

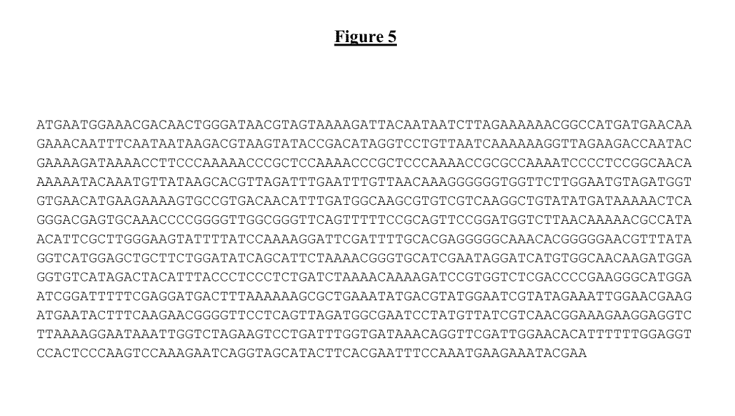

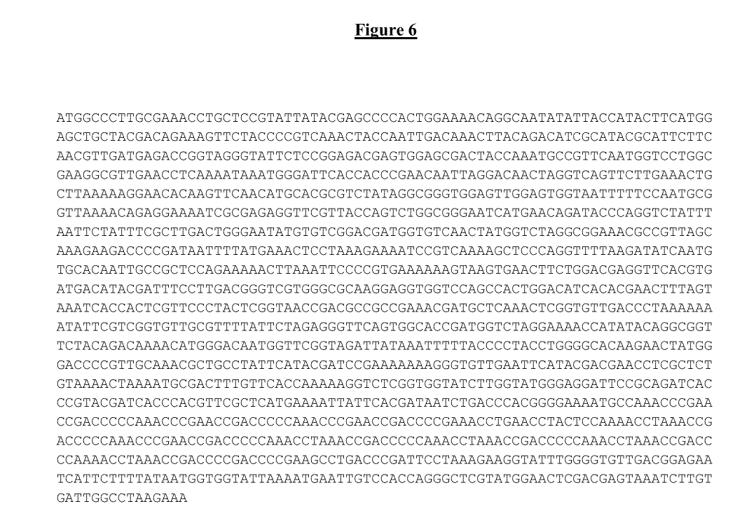

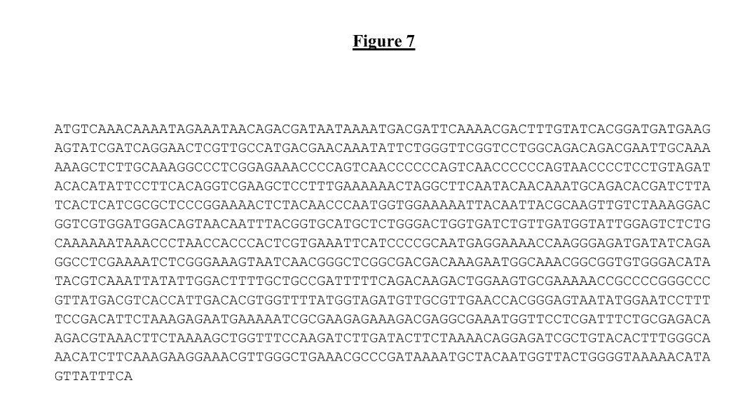

Enzymes isolated from cell-lytic organisms such as the PBCV-1 virus are also suitable for use in the methods described herein. Cell wall degrading enzymes from such viruses may be cloned and expressed in organisms such as E. coli. Enzymes purified from these organisms may be used to treat cells. The nucleotide and amino acid sequences of exemplary PBCV-1 cell degrading enzymes are disclosed in Table 1 and FIGS. 2-7.

In addition to exogenous enzymes, cells may express enzymes endogenously under appropriate expression controls such that regulated enzymatic degradation at an appropriate time can be achieved to facilitate economic lipid extraction from oil-rich algal cells. Nucleic acids encoding any of the enzymes described herein may be cloned, inserted into an appropriate expression vehicle, and inserted into the target cell. The nucleic acids may be expressed under the control of a constitutive or inducible promoter system. Such engineered cells may thus express the cell wall degrading enzymes constitutively or in response to an induction stimulus.

In certain embodiments, a nucleic acid may be identical to the sequence represented as SEQ ID NO:1, 3, 5, 7, 9, or 11. In other embodiments, the nucleic acids may be least about 80%, 81%, 82%, 83%, 84%, 85%, 86%, 87%, 88%, 89%, 90%, 91%, 92%, 93%, 94%, 95%, 96%, 97%, 98% or 99% identical to SEQ ID NO:1, 3, 5, 7, 9, or 11, or 80%, 81%, 82%, 83%, 84%, 85%, 86%, 87%, 88%, 89%, 90%, 91%, 92%, 93%, 94%, 95%, 96%, 97%, 98% or 99% identical to SEQ ID NO:1, 3, 5, 7, 9, or 11. Sequence identity calculations can be performed using computer programs, hybridization methods, or calculations. Exemplary computer program methods to determine identity and similarity between two sequences include, but are not limited to, the GCG program package, BLASTN, BLASTX, TBLASTX, and FASTA. The BLAST programs are publicly available from NCBI and other sources. For example, nucleotide sequence identity can be determined by comparing query sequences to sequences in publicly available sequence databases (NCBI) using the BLASTN2 algorithm.

The nucleic acid molecules exemplified herein encode PBCV-1 virus polypeptides with amino acid sequences represented by SEQ ID NO:2, 4, 6, 8, 10, and 12. In certain embodiments, the polypeptides may be at least about 80%, 81%, 82%, 83%, 84%, 85%, 86%, 87%, 88%, 89%, 90%, 91%, 92%, 93%, 94%, 95%, 96%, 97%, 98% or 99% identical to SEQ ID NO:2, 4, 6, 8, 10, and 12 and possess cell wall degrading function. The present disclosure encompasses algal cells such as Chlorella cells that contain the nucleic acid molecules described herein or express the polypeptides described herein.

Suitable vectors for gene expression may include (or may be derived from) plasmid vectors that are well known in the art, such as those commonly available from commercial sources. Vectors can contain one or more replication and inheritance systems for cloning or expression, one or more markers for selection in the host, and one or more expression cassettes. The inserted coding sequences can be synthesized by standard methods, isolated from natural sources, or prepared as hybrids. Ligation of the coding sequences to transcriptional regulatory elements or to other amino acid encoding sequences can be carried out using established methods. A large number of vectors, including algal, bacterial, yeast, and mammalian vectors, have been described for replication and/or expression in various host cells or cell-free systems, and may be used with genes encoding the enzymes described herein for simple cloning or protein expression.

Certain embodiments may employ algal promoters or regulatory operons. The efficiency of expression may be enhanced by the inclusion of enhancers that are appropriate for the particular cell system that is used, such as those described in the literature. Suitable promoters also include inducible algal promoters. Expression systems for constitutive expression in algal cells include, for example, the vector pCHLAMY1. Inducible expression systems include those such as pBAD24 (induced by the addition of arabinose) or IPTG inducible vectors. For algae, cold shock or other stress-induced (e.g., pH) promoters may be suitable. Other suitable inducible expression systems include those based on the nitrate reductase promoter from Phaeodactylum tricornutum (e.g., pPt-ApCAT) or the carbonic anhydrase promoter of Dunaliella salina (e.g., pMDDGN-Bar).

In exemplary embodiments, the host cell may be a microbial cell, such as a yeast cell or an algal cell, and may be from any genera or species of algae that is known to produce lipids or is genetically manipulable. Exemplary microorganisms include, but are not limited to, bacteria; fungi; archaea; protists; eukaryotes, such as a algae; and animals such as plankton, planarian, and amoeba Non-limiting examples of cells suitable for use include diatoms (bacillariophytes; including those from the genera Amphipleura, Amphora, Chaetoceros, Cyclotella, Cymbella, Fragilaria, Hantzschia, Navicula, Nitzschia, Phaeodactylum (e.g., Phaeodactylum tricornutum CCMP632), and Thalassiosira), green algae (chlorophytes; including those from the genera Ankistrodesmus, Botryococcus, Chlorella, Chlorococcum, Dunaliella, Monoraphidium, Oocystis (e.g., Oocystis pusilla OOCYS1), Scenedesmus, and Tetraselmis), blue-green algae (cyanophytes; including those from the genera Oscillatoria and Synechococcus), golden-brown algae (chrysophytes; including those from the genera Boekelovia) and haptophytes (including those from the genera Isochrysis and Pleurochrysis). Additional examples include species from the genera Ellipsoidon (e.g., ELLIP1), Franceia (e.g., FRANC1), Nannochloris (e.g., NANNO2), Nannochloropsis (e.g., NANNP2), and Selenastrum (e.g., S. capricornutum UTEX1648). In certain embodiments, the cell is a Chlorella vulgaris cell, such as Chlorella vulgaris UTEX 395.

Host cells may be cultured in an appropriate fermentation medium. An appropriate, or effective, fermentation medium refers to any medium in which a host cell, including a genetically modified microorganism, when cultured, is capable of producing lipids. Such a medium is typically an aqueous medium comprising assimilable carbon, nitrogen and phosphate sources, but can also include appropriate salts, minerals, metals and other nutrients. Microorganisms and other cells can be cultured in conventional fermentation bioreactors or photobioreactors and by any fermentation process, including batch, fed-batch, cell recycle, and continuous fermentation. The pH of the fermentation medium is regulated to a pH suitable for growth of the particular organism. Culture media and conditions for various host cells are known in the art. A wide range of media for culturing algal cells, for example, are available from ATCC.

Algae may be grown in reservoir structures, such as ponds, troughs, or tubes, which are protected from the external environment and have controlled temperatures, atmospheres, and other conditions. Such reservoirs can also include a carbon dioxide source and a circulation mechanism. External reservoirs such as large ponds or captive marine environments may also be used. In one embodiment, a raceway pond can be used as an algae growth reservoir in which the algae is grown in shallow circulating ponds with constant movement around the raceway and constant extraction or skimming off of mature algae. Other examples of growth environments or reservoirs include bioreactors.

Isolation or extraction of lipids from the enzyme-degraded cells may be aided by mechanical processes such as crushing, for example, with an expeller or press, by supercritical fluid extraction, or the like. Once the lipids have been released from the cells, they can be recovered or separated from a slurry of debris material (such as cellular residue, enzyme, by-products, etc.). This can be done, for example, using techniques such as sedimentation or centrifugation. Recovered lipids can be collected and directed to a conversion process if desired.

One method of extracting lipids from cells that may be used with the cell wall degradation methods described above (or to extract lipids from any cell sample) is a solvent extraction using, for example, a mixture of a non-polar solvent (e.g., hexane) and a polar solvent (e.g., isopropanol). Exemplary non-polar solvents include liquid alkanes such as pentane, hexane, heptane, octane, nonane or decane, while exemplary polar solvents include alcohols such as ethanol, propanol, or butanol (including the iso-forms such as isopropanol and isobutanol). Solvents are typically mixed at ratios ranging from 1:1 to 5:4 (vol/vol), and the solvent mix ratios may be tested to ensure full single-phase mixing. As demonstrated in the Example below, such a solvent extraction increases the amount of lipids that may be extracted from enzyme-treated cells.

Cell slurries (for example, resulting from treatment of algal cells with cell wall degrading enzymes) may be mixed with solvents such as hexane and isopropanol for a period of time ranging from several minutes to several hours. The resulting solvent fraction may be separated from the solids fraction by, for example, centrifugation. Solvent phases may be separated by, for example, decanting or solvent aspiration. Lipids may then be isolated from the solvent fraction by removing the solvent and further purified or fractionated as desired. For example, lipids may be removed from the isolated solvent phase by vacuum distillation, allowing for recycling of the solvents for subsequent extractions, leaving behind the pure lipid fraction. Cell samples may be dewatered to alter the percentage of solids in the sample prior to the solvent extraction.

Solvent extraction may be carried out at any temperature within the range of 10° C. to 50° C. or at a temperature ranging from about 18° C. to 30° C. Exemplary temperatures include 10, 15, 20, 25, 30, 35, 40 45 or 50° C. In some embodiments, the solvent extraction is carried out at between 18° C. and 25° C., such as at 18, 19, 20, 21, 22, 23, 24 or 25° C.

The amount of time needed for the solvent extraction will vary with the sample size and other experimental parameters, but typically will range from 15 minutes to 12 hours. Exemplary times range from 30 minutes to 6 hours, such as 0.5, 1, 1.5, 2, 2.5, 3, 3.5, 4, 4.5, 5, 5.5, or 6 hours, or range from 1 to 4 hours. In certain embodiments, the solvent extraction is carried out for at least one hour or for less than 4 hours.

The percentage of solids in the cell suspension (e.g., aqueous algal or yeast cell suspension) used for the solvent extraction may vary from about 5% solids to about 90% solids, or from about 10% to about 40% solids. Examples include at least 5, 10, 15, 20, 25, 30, 35, or 40% solids.

The solvent used for the lipid extraction typically comprises a mixture of a non-polar solvent (e.g., hexane) and a polar solvent (e.g., isopropanol), but the relative volumes of the solvents can vary. Typically, the solvents may be used at any ratio of non-polar:polar solvent that generates a single phase solvent mixture. Exemplary ratios of hexane:isopropanol (volume to volume) are 1:1, 2:1, 2:3, 3:1, 3:2, 3:4, 3:5, 4:1, 4:3, 4:5, 5:1, 5:2, 5:3, or 5:4. The volume of solvent mix added to the cell slurry can range from about 0.5:1 to 3:1 and typically is 1:1.

The weakening or degrading of the cell walls may also serve as a form of “pretreatment” to the recalcitrant cell walls and thereby provide for easier use of the residual biomass post oil removal. The weakened algal cell walls may also be more permeable to DNA and may thus facilitate transformation of green algae. By making the cell walls weak and or completely digesting them, the cells are easy to break and the oils then become easy to collect. Treating with enzymes may also make the residual algal biomass easily fermentable in downstream processes.

### EXAMPLE

### Example 1

A 2 liter culture of Chlorella vulgaris UTEX 395 biomass was concentrated to 10% solids (dry weight basis) and 1.2 mg enzymes (combined 8 μg A94L, 206 μg A215L and 960 μg A292L) were added. This loading corresponds to 3 mg/g (enzyme/biomass), which is about 10-fold less enzyme per gram than is typically used for saccharification of cellulosic biomass. This mixture was tumbled end-over-end at room temperature (about 20° C.) for approximately 16 hours.

Triplicate samples of enzyme pretreated and untreated (control) aqueous algal biomass slurries (3 ml) were then extracted at room temperature with 3 ml of a 3:2 (v/v) hexane:isopropyl alcohol (H:IPA) mixture while stirring continuously for 2 hours with occasional manual shaking. Two fractions were generated: the H:IPA extractant fraction and the solid residue fraction. The two fractions were separated by transferring the samples into centrifuge compatible tubes and centrifuging at 11,000 rcf for 10 minutes. The subsequent fractions were then placed into pre-weighed glass vials. H:IPA fractions were immediately dried under nitrogen and transferred to a 40° C. vacuum oven for further drying. The solid residue was transferred quantitatively into pre-weighed vials, dried under nitrogen and transferred to a 40° C. vacuum oven for further drying.

After drying, the fractions were weighed and prepared for fatty acid methyl ester (FAME) analysis. A 10 mg sample was transferred into a pre-weighed 2 ml glass vial and the vials were dried in a 40° C. vacuum oven overnight before a final sample weight was recorded. The solid residue fractions were scraped down and homogenized and approximately 10 mg of sample was weighed out into a 2 ml glass vial. Samples were analyzed for fatty acid content through an in situ FAME determination (as detailed in Laurens et al., Anal. Bioanal. Chem., 403:167-178 (2012)) in triplicate where fraction sizes were large enough.

Total lipid content in the original biomass sample was measured as total FAME, and this value was used to calculate the recovery of fatty acid fractionation in the process. Samples containing 7-10 mg of each freeze-dried sample were weighed out in triplicate and dried overnight in a 40° C. vacuum oven before a final weight was recorded. The resulting FAME content in each fraction was summed and normalized to the whole biomass introduced into the pretreatment experiment. The biomass in the reaction was estimated based on dissolved biomass estimates from triplicate experiments. The recovery of FAME calculation is based on a comparison of the sum of FAME in the fractions to the respective FAME content of the biomass from which they were derived.

The results presented in Table 4 illustrate a 7-8 fold increase in lipid extraction efficiency after enzyme treatment of Chlorella cells as compared to the control (untreated) cells.

TABLE 4
Lipid extraction efficiency in enzyme treated and control cells

| | | | FAME in | |
|---|---|---|---|---|
| | Gravimetric | In-situ FAME | extracted cell | |
| | extraction | extraction | residue | Recovery |
| | (% DW) | (% DW) | (% DW) | (%) |
| Enzyme | 6.9 ± 1.8 | 5.6 ± 1.6 | 27.8 ± 2.7 | 89.3 ± 3 |
| Control | 1 ± 0.1 | 0.7 ± 0.1 | 31.6 ± 0.2 | 86.3 ± 0.3 |

A 7-fold increase in gravimetric extraction efficiency was observed, but not all gravimetrically extracted lipids are fatty acids useful for fuels. The fraction of fatty acids in lipids is likely a more accurate way to determine efficiency of extraction. The combination of FAME in extracted lipid allows us to determine the ‘purity’ of the lipids. The average percentage of fatty acids per lipids extracted after enzymatic treatment (81%+/−1.5%) was higher than in control cells (62.1%+/−1.4%) and thus the enzymatic treatment results in less interfering non-lipid components.

As shown in Table 5 below, the extracted lipids after enzyme treatment also have a FAME profile that is enriched in oleic acid (C18:1n9), which is often correlated with neutral lipids and indicates that the enzyme treatment selectively extracts more neutral lipids compared with the control.

TABLE 5
FAME profile in extracted oils relative to the
whole biomass (reference)

| Fatty Acid | Enzyme | Control | Reference |
|---|---|---|---|
| C14:0 | 0.2 | 0.5 | 0.2 |
| C16:4 | 0.3 | 0.6 | 0.2 |
| C16:3 | 2.8 | 2.6 | 2.9 |
| C16:2 | 0.0 | 0.0 | 0.0 |
| C16:1n9 | 8.8 | 10.2 | 8.5 |
| C16:1n11 | 0.2 | 0.4 | 0.0 |
| C16 | 16.0 | 19.4 | 14.9 |
| C18:2 | 11.4 | 10.5 | 11.2 |
| C18:1n9 | 42.2 | 27.2 | 46.2 |
| C18:3 | 14.5 | 23.6 | 12.9 |
| C18:0 | 2.5 | 3.5 | 2.5 |
| C20:0 | 0.3 | 0.6 | 0.2 |
| C22:0 | 0.3 | 0.0 | 0.2 |
| C24 | 0.5 | 1.1 | 0.2 |

The Example discussed above is provided for purposes of illustration and is not intended to be limiting. Still other embodiments and modifications are also contemplated.

While a number of exemplary aspects and embodiments have been discussed above, those of skill in the art will recognize certain modifications, permutations, additions and sub combinations thereof. It is therefore intended that the following appended claims and claims hereafter introduced are interpreted to include all such modifications, permutations, additions and sub-combinations as are within their true spirit and scope.

We claim:

1. A method for recovering lipids from a cell, comprising:
a) contacting the cell with at least one cell wall degrading enzyme; and
b) isolating lipids from the cell.

2. The method of claim 1, wherein the at least one cell wall degrading enzyme is a proteinase, chitinase, chitosanase, sulfatase, lyticase, lysosyme, alginate lyase or pectate lyase.

3. The method of claim 1, wherein the at least one cell wall degrading enzyme is A94L, Al22R, A181/182R, A215L, A260R, or A292L from the Chlorella virus PBCV-1.

4. The method of claim 1, wherein the cell is a microbial cell.

5. The method of claim 1, wherein the cell is an algal or a yeast cell.

6. The method of claim 5, wherein the algal cell is from the genus Chlorella, Nannochloropsis, or Selenastrum.

7. The method of claim 6, wherein the algal cell is a strain of the species C. vulgaris.

8. The method of claim 1, wherein the cell expresses at least one exogenous gene encoding a cell wall degrading enzyme.

9. The method of claim 8, wherein the at least one exogenous gene encoding a cell wall degrading enzyme is under the control of an inducible promoter.

10. The method of claim 9, wherein the step of contacting the cell comprises inducing the expression of the at least one exogenous gene encoding a cell wall degrading enzyme.

11. The method of claim 10, wherein the at least one exogenous gene encoding a cell wall degrading enzyme is isolated from the Chlorella virus PBCV-1.

12. The algal cell of claim 11, wherein the at least one exogenous gene encoding a cell wall degrading enzyme is A94L, Al22R, A181/182R, A215L, A260R, or A292L.

13. The method of claim 12, further comprising contacting the algal cell with an externally added cell wall degrading enzyme.

14. The method of claim 1, further comprising a step of dewatering the cell prior to the step of contacting the cell with at least one cell wall degrading enzyme.

15. The method of claim 14, wherein the cell is dewatered to about 10-40% solids prior to the step of contacting the cell with at least one cell wall degrading enzyme.

16. The method of claim 1, wherein the step of isolating lipids from the cell comprises extracting the lipids by mixing the contacted cells with a hexane/isopropanol solvent and recovering the lipids from the solvent.

17. The method of claim 16, wherein extracting the lipids is carried out at a temperature of about 18° C. to 30° C.

18. The method of claim 16, wherein extracting the lipids is carried out for about 1 to 4 hours.

19. The method of claim 16, wherein the solvent is 3:2 hexane:isopropanol by volume.

20. A method for recovering lipids from an algal cell, comprising:
a) culturing the algal cell;
b) inducing expression of a cell wall degrading enzyme in the algal cell; and
c) extracting lipids from the algal cell by mixing the algal cell with a hexane/isopropanol solvent, separating out the solids, and recovering the lipids from the solvent.
